(19) United States
(12) Patent Application Publication
(10) Pub. No.: US 2005/0063419 A1
(43) Pub. Date: Mar. 24, 2005

(54) Method of creating, controlling, and maintaining a wireless communication mesh of piconets

(76) Inventors: Mark E. Schrader, Rochester, NY (US); Eric Frayer, New York, NY (US)

Correspondence Address: Thomas R. FitzGerald, Esq., 16 E. Main St., Suite 210, Rochester, NY, 14614-1803, US

(21) Appl. No.: 10/900,586

(22) Filed: Jul. 23, 2004

Related U.S. Application Data
(60) Provisional application No. 60/490,388, filed on Jul. 25, 2003.

(51) Int. Cl. H04L 12/403

(52) U.S. Cl. 370/466; 370/329

(57) ABSTRACT

A method of controlling and sharing access to a wireless network wherein some stations of the network may be out of range of other stations of the network. The method includes the steps of: first, each station periodically transmits a beacon containing a bit map having a bit location for every station on the network and monitoring the beacons of stations within its range; second, in response to a beacon being no longer detected, each station transmits a bit map containing an indication of only the stations that it can still receive; third, on receiving a bit map with not all stations indicated, each station responds by adding stations that it can receive to the received bit map and transmitting the updated bit map; fourth, each station repeats the third step until the updated bit map indicates that all stations are still in the network or that a station is missing from the network; and finally, if a station is indicated to be missing from the network, each station updates the bit map. Through the application of these steps, the invention controls access to the network without a global master. The present invention has the advantage of controlling a network without the need for a central master station, and does not require continuous global knowledge of the topology of the network.

### CROSS-REFERENCE TO RELATED APPLICATIONS

This application claims the benefit of the filing date of U.S. Provisional patent application Ser. No. 60/490,388 filed Jul. 25, 2003.

### FIELD OF THE INVENTION

This invention is directed to an ad hoc method of controlling and sharing access to a wireless communication mesh of smaller wireless communication networks (piconets), wherein the mesh can be created and modified at any time in any location without the need for a central master station.

### BACKGROUND OF THE INVENTION

Wireless communication protocols must handle three distinct situations, a network or station joining an established network, a network or station leaving the network, and a station roaming within the network. To accomplish this there must be a way for piconet masters to communicate their presence to all other master stations within range, and communicate changes in what master stations they can hear. In prior art time division multiple access (TDMA) protocols, each master station is assigned a periodic time slot in which to transmit a beacon. In the prior art TDMA protocols, a central master station is required to administer the time slots to the members of the network. In a network where some of the members are out of range of other members, the ability of a central master to communicate with all members of the network may not exist.

Furthermore, in an ad hoc network where member stations are joining and leaving the network at random, there may not be a suitable candidate as the master station. There is a need therefore for an improved protocol for managing access to an ad hoc network that does not require a central master station.

### SUMMARY OF THE INVENTION

The invention provides a method of controlling and sharing access to a wireless network wherein some stations of the network may be out of range of other stations of the network. The invention's method includes the steps of: first, each station periodically transmits a beacon containing a bit map having a bit location for every station on the network and monitoring the beacons of stations within its range; second, in response to a beacon being no longer detected, each station transmits a bit map containing an indication of only the stations that it can still receive; third, on receiving a bit map with not all stations indicated, each station responds by adding stations that it can receive to the received bit map and transmitting the updated bit map; fourth, each station repeats the third step until the updated bit map indicates that all stations are still in the network or that a station is missing from the network; and finally, if a station is indicated to be missing from the network, each station updates the bit map. Through the application of these steps, the invention controls access to the network without a global master.

The present invention has the advantage of controlling a network without the need for a central master station, and does not require continuous global knowledge of the topology of the network.

### Glossary of Terms and Abbreviations Used in This Specification

APB—Audible Piconet Bitmap: the position of each bit represents the PIN of a member of the mesh. A “1” in a bit position means that the corresponding member of the mesh is in range and is audible.
APC—Audible Piconet Count: The number of members of the mesh that the APC's possessor can hear.
APC1—Audible Piconet Count (Join Facilitator): The number of members of the Join Mesh that the Join Facilitator can hear.
APC2—Audible Piconet Count (Merge Synchronizer): The number of members of the Merge Mesh that the Merge Synchronizer can hear.
ASB—Available Slot Bitmap
BCC—Beacon Cycle Count.
BCN—Beacon Cycle Number, in effect a cyclical “clock time” within a piconet mesh
BDBF—Beacon Detect Bitmap/Flag.
CEC—Change Effect Cycle count: The future BCN when changes will take effect.
CEC0—The time needed to propagate Merge Start, plus one beacon cycle in the Re-Sync network (2). This is the beacon cycle on which this network will go silent except for the watchdog timing.
CECa—The beacon cycle ending the propagation of the Join-Merge information thoughout Join-Merge network (1)
CECa1—
CECa2—
CECb—Beacon cycle ending the propagation of the Re-Sync information thoughout Re-Sync network (2).
CECb1—
CECb2—
CLF—Command or Data Length Field
CPF—Command Parameters or Data Field
CTF—Command or Data Type Field
DBCN1—Estimated number (D=Delta for change) of Join Network beacon cycles required to propagate a beacon command throughout the network when the command was initiated by the Merge Synchronizer. In effect, the value of DBCN2 expressed in units of the join network's beacon cycles.
DBCN2—Estimated number (D=Delta for change) of Merge Network beacon cycles required to propagate a beacon command throughout the network when the command was initiated by the Merge Synchronizer.
DF—Data Field
DLF—Data Length Field
DTF—Data Type Field
JMR—Join Merge Resync
JMR-WTO (JMRTO)—Join Merge Resync timeout for the entire process
JPM—Joined Piconet Master
Mesh—a set of mutually-intercommunicating piconets
MID—Mesh ID Number—constant for all Joined Piconet Masters in this mesh
MID1—MID of mesh containing the Join Facilitator Master
MID2—MID of mesh containing the Unjoined Piconet Master
MID3—MID of mesh containing the Merge Synchronizer Master
MRS—Merge-Resysnc Start
MRS-WTO (MRSTO)—Merge-Resysnc Start watchdog timeout
NBD—No Beacon Detect indication
Network—a set of mutually-intercommunicating piconet meshes
NMF—New Mesh Flag to indicate an impending join to the mesh by a mesh or single piconet master. NMF=0 means no impending join is about to occur; NMF=1 means merge in progress; NMF=2 means resynchronization in progress.
NMM—Number of piconet masters in the mesh initiating the join
NMS—New Mesh Size, the number of piconets in the joining mesh
NNF—New Network Flag
NTM—Number of Total Members: The total number of members (joined piconet masters) in a mesh.
NTM1—Original number of members in the Join Mesh
NTM2—Original number of members in the Merge Mesh
NTM3=NTM2+1, total size of network to merge (includes the Unjoined Piconet Master)
NTM4=NTM1+NTM2+1, Total members of the merged network (includes the Unjoined Piconet Master)
Piconet—a subnetwork in a small physical zone made up of one or more wireless, mutually-intercommunicating electronic devices
PIN—Piconet Index Number—The unique index assigned to each member of the mesh
PIN1—Before join-merge-resync PIN of Join Facilitator
PIN2—Before join-merge-resync PIN of Merge Facilitator
PIN3—After join-merge-resync PIN of original unjoined piconet master=NTM1+1
PIN4—Afterjoin-merge-resync PIN of Merge Facilitator (formerly PIN2)=PIN2+NTM1+1
PIN1-s—The smallest PIN of the following set: {PIN1, the PIN value of each JPM within range of the JPM PIN1}
PIX—Piconet Index
RSS-WTO (RSSTO)—Merge Start to Resync Start timeout: timeout to guarantee that the Join is completed and the UPM starts the Resync.
Secondary slot—Becomes available when a network is spread out enough that not all piconets in that network can hear each other. A piconet can use the time slot of a beacon sent by an unheard piconet to transmit information to other piconets also out of range of the unheard beacon.
SSB—Secondary Slot Bitmap
TDMA—Time Division Multiple Access
TMM—total number of joined piconets in the mesh
UPM—Unjoined Piconet Master

### BRIEF DESCRIPTION OF THE DRAWINGS

FIG. 1 is a diagram illustrating the beacon employed by a piconet master station according to the present invention.

FIG. 2 is a flow chart showing the process of adding a piconet master station to the mesh according to the present invention.

FIGS. 3a and b are maps showing meshes having joined and unjoined linear topology, respectively.

FIGS. 4a and 4b are maps showing a mesh having a nonlinear topology, with FIG. 4a showing the mesh with all piconets, and FIG. 4b showing the same mesh after one piconet has left.

FIG. 5 is a flow chart showing the process of dropping a piconet master station from the mesh according to the present invention.

FIGS. 6a and 6b are maps showing a mesh having a nonlinear topology, with FIG. 6a showing the mesh with all piconets, and FIG. 6b showing the same mesh after two piconets have left during the same time interval.

FIGS. 7a through 7f are maps showing the stages of joining an unjoined piconet master, a join mesh, and a merge mesh, in the case where the join mesh's join time exceeds the merge mesh's beacon turn-off time.

FIGS. 8a through 8f are maps showing the stages of joining an unjoined piconet master, a join mesh, and a merge mesh, in the case where the join mesh's join time is less than or equal to the merge mesh's beacon turn-off time.

FIGS. 9a through 9c are message flow diagrams showing the general message flow during the joining of an unjoined piconet master, a join mesh, and a merge mesh, in the case where the join mesh's join time is greater than the merge mesh's beacon turn-off time.

FIGS. 9d through 9f are message flow diagrams showing the general message flow during the joining of an unjoined piconet master, a join mesh, and a merge mesh, in the case where the join mesh's join time is less than or equal to the merge mesh's beacon turn-off time.

### DETAILED DESCRIPTION OF THE INVENTION

The invention addresses the issue of networking piconets in an ad hoc wireless network through the use of multiple piconet masters and no network master. The invention establishes a protocol where a wireless network can be created at any time in any location. The invention's protocol also provides a way to exploit unused network bandwidth without interfering with any members of the network, rendering the invention both more effective and more efficient than conventional methods of creating wireless networks.

The invention's protocol handles three distinct situations: a network joining an established network, a piconet leaving the network, and a piconet roaming within the network. To accomplish each of these changes, the piconet masters communicate their presence to all stations within range, and communicate changes in what stations they can hear. A small time slot has been set aside for this purpose at the end of each piconet's assigned time slot. This small slot of time is called the beacon.

The Beacon

The beacon is an important part of each timeslot. The information contained in the beacon allows an individual piconet to determine local area knowledge, and network changes based on this knowledge. The information carried by each piconet's beacon includes:
Mesh ID (MID),
Beacon Cycle Count (BCC), the number of cycles that have passed since the network was established
Piconet Index Number (PIN), a number assigned to each piconet when it joins the network
Number of Total Members (NTM), the total number of piconets in the network
Beacon Detect Bitmap/Flag (BDBF), a bitmap that keeps track of the presence of the other piconets in the network
New Network flag (NNF), a one-bit flag that is set off when a piconet detects another network wanting to join
Secondary Slot Bitmap (SSB), a bitmap the same size as the BDBF used exclusively to inform all other piconets in range which secondary slots the broadcasting piconet took
Change Effect Cycle count (CEC), the cycle count on which a new network configuration will take effect.

Table 1 summarizes the above list. The BCC is determined and incremented by the root piconet. The root is the piconet with the lowest piconet ID number in the network. Piconets with low ID numbers entered the network before piconets with higher numbers. An ID number can change when a piconet leaves the network, or a new piconet is added.

In the BDBF bitmap, the bit order corresponds to the piconet ID number. One bit in the bitmap is reserved for each piconet in a network. The most significant bit refers to piconet 1 and the least significant refers to the most recent one to join the network. The meaning of a “1” in BDBF bit position k is “at least one piconet master in this network of piconets can hear the beacon of piconet k”. Should a piconet fail to detect a beacon it has detected in the previous cycle, it resets the BDBF it sends to all zeros and propagates the zeros throughout the network until all piconets in the network have a BDBF of all zeros.

The secondary slot bitmap (SSB) prevents two piconets in range of each other from attempting to use the same secondary slot at the same time. If they did use the same slot at the same time then their signals would interfere with each other.

The Change Effect Cycle count (CEC) is determined by adding the current cycle count, BCC, to a value called delta-T, or ΔT (in units of cycle counts). ΔT represents a time delay estimate, based on cycles of beacon transmission, needed to perform required tasks before the action takes effect. The value of ΔT varies depending on the number of piconets in the network, and the action that is taking place. (ΔT values will be explained for each action as they are subsequently described.) The beacon also serves as an invitation for new piconet masters to join the network. A new master can respond to any beacon in the network with a request to join.

TABLE 1
Information Contained in the Beacon

| Name | Description |
|---|---|
| Beacon Cycle | The number of cycles that have passes since |
| Count (BCC) | the network was established. |
| Piconet Index | The number given to each piconet to determine |
| Number (PIN) | the order in which it joined the network. This |
| | number can change if a piconet leaves, or a new |
| | network is added to the current network. |
| Number of Total | The current number of piconets in the network |
| Members (NTM) | |
| Beacon Detect | A Bitmap that each piconet uses to resolve changes |
| Bitmap Flag | in piconet topology involving a node dropout. |
| (BDBF) | When a piconet either leaves or is added this |
| | bitmap is either shortened or lengthened. |
| New Network | The flag used to signal that this change is |
| Flag (NNF) | associated with a new network wanting to join. |
| Secondary Slot | This bitmap is the same size as the BDBF except |
| Bitmap (SSB) | it is only used to determine which secondary |
| | slots are taken by any piconets within range. |
| Change Effect | This is the cycle count when a new network |
| Cycle Count | configuration will take place. |
| (CEC) | |

Two other bitmaps are used, but they are not transmitted in the beacon. The first is called the audible piconet bitmap, APB. The APB is an empty bitmap of all timeslots that are in existence. The information stored in the APB is a map of the other piconets that a piconet master can hear. This is useful for rebuilding the network after a change is detected. The APB will be logically OR-ed with all received BDBF values when a piconet leaves, or moves around the network. The logical OR of all APBs will show any no-longer-audible piconets as zeroes in the result.

The differences between the APB and BDBF are subtle. The BDBF should always be all ones except during the times when a CEC is received and when that CEC is reached. It is also used to detect if a piconet left the network. If there are still zeros in the BDBF after a CEC is reached then the BDBF is compressed and the corresponding piconet is dropped from the network. The APB should be a mixture of ones and zeros depending on which other piconets can be heard by that given piconet.

The second bitmap that is used but not transmitted in the beacon is call the Available Slot Bitmap (ASB). The ASB should initially look the same as the APB. However, as other piconets take secondary time slots the ASB is filled in, while the APB always indicates what piconets' beacons can be heard. A piconet will reference the ASB to see which non-audible slots are still free for use. Any slot with a zero is an available slot, but before an extra slot can be taken, a piconet wanting to use that slot must wait one full cycle before claiming it. This delay ensures that the corresponding bit in the SSB of every piconet within range has been monitored for a “0” indicating that the slot is “not in use” . A “1” in any SSB indicates that the slot has already been claimed by an audible piconet.

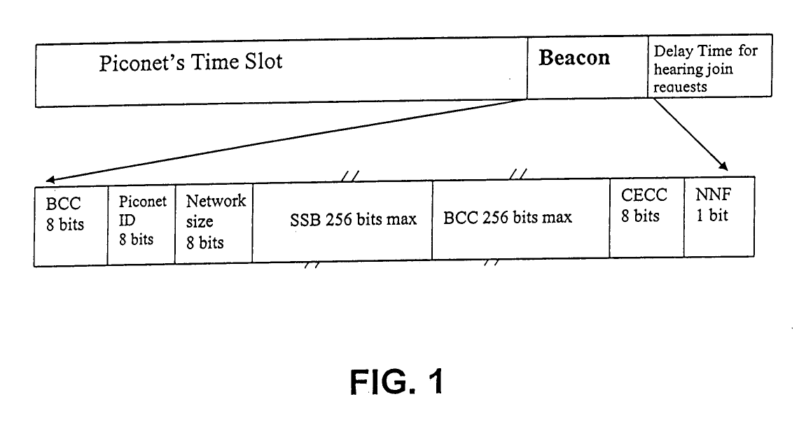

FIG. 1 is a drawing of the packet structure for each time slot and a detailed drawing of the beacon packet structure 5. By this model a Morphological Wireless Network could support 255 different piconets at one time. For a three-piconet network, beacon data 10 would only occupy 39 bits, which is fewer than 5 bytes of data. The lengths of the beacon data for other network sizes are shown in Table 2 below.

TABLE 2
A sample of Beacon sizes
given a number of piconets in a network.

| | For 7 piconets | For 20 piconets | For 75 piconets |
|---|---|---|---|
| | in a network | in a network | in a network |
| Information | Packet Size | Packet Size | Packet Size |
| BCC | 8 bits | 8 bits | 8 bits |
| ID number | 8 bits | 8 bits | 8 bits |
| Number | 8 bits | 8 bits | 8 bits |
| piconets | | | |
| in Network | | | |
| SSB | 7 bits | 20 bits | 75 bits |
| BDBF | 7 bits | 20 bits | 75 bits |
| CEC | 8 bits | 8 bits | 8 bits |
| NNF | 1 bits | 1 bits | 1 bits |
| Total Beacon | 47 bits | 73 bits | 183 bits |
| Size | | | |

Operation of the Invention

The process of managing a morphological network must consider all possible scenarios: adding together two networks, removing a piconet from the network, and movement of a piconet within the network. Each scenario is different but this invention allows all scenarios to be treated in similar and consistent ways.

Adding a Network to Another Network

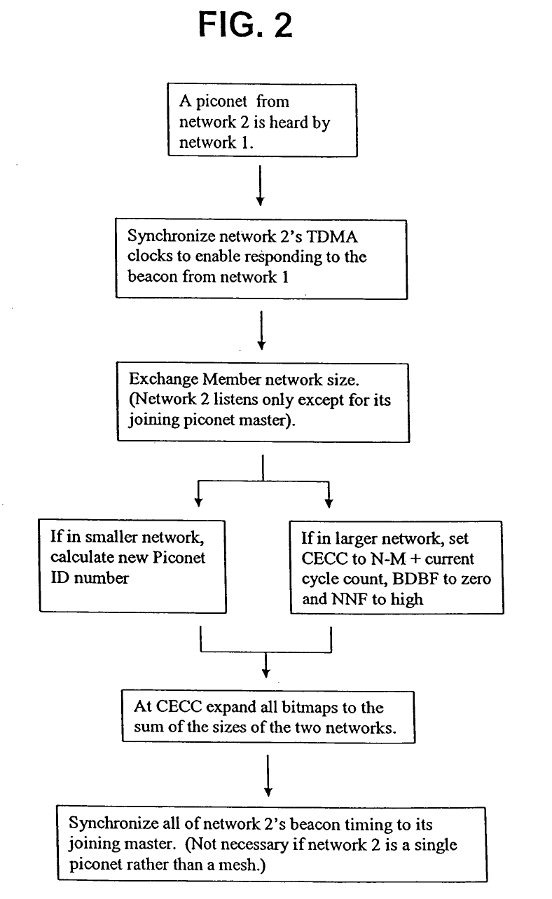

FIG. 2 is a flow diagram showing the process of adding a network from the perspective of a piconet in a network. If any piconet from one network comes into contact with a piconet from another network, the two networks must join. The following is a list of the sequence of actions that occur in adding network 2 to network 1. The size of a network can be as small as a single piconet.

Refer to FIG. 2. At the first step 21, two piconets of different networks detect each other. The piconets exchange their overall network sizes at step 23. The smaller network submits a request to join the larger network. In this illustration, network 2 requests to join network 1.

Except for its joining piconet master (not a network master), piconet 2 shuts down temporarily to eliminate interference and as the first step in resynchronization of network 2 to the timing of network 1.

In step 24a, the (smaller) network 2 gets new ID numbers that are calculated by adding their current ID number to the size of the larger network. The smaller network also adopts the larger network's cycle count. The new network size becomes the sum of the sizes of the two networks.

The detecting piconet from the (larger) network 1 sets the New Network Flag in step 24b, adjusts the CEC for the expanded bitmaps in step 25, and sets its BDBF to zero. It propagates these data elements in its beacon and consequently all other piconets adopt the expanded CEC, set their BDBF to zero, and propagate the signal in their beacons. (Here, ΔT=N−M−1 where N is the number of piconets in the joined network and M is the number of piconets that the CEC-setting piconet can hear. The worst-case cycle count would be N−1 if the CEC-setting piconet can only hear one other piconet—if it can hear M piconets, that fact reduces the worst-case count by M.)

By step 25, after this CEC is reached in the beacon cycles, the bitmaps have all been expanded to the appropriate size, and the NNF is then set back to zero.

Another CEC is now set to find out what piconets are present. At this CEC the bitmap will be compressed if any zeros are still in the BDBF. This ΔT value will be N−M.

Dropping a Piconet from the Network

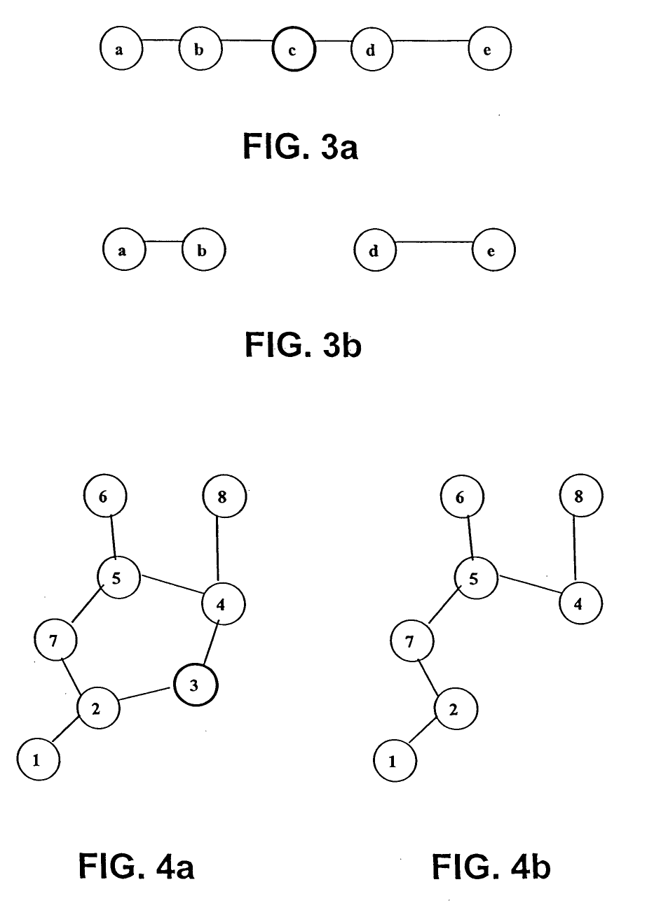

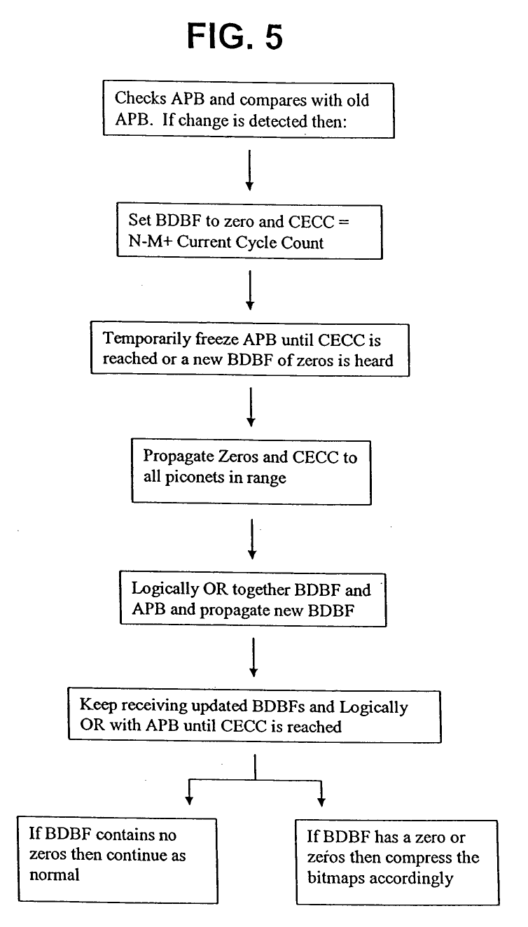

A piconet may move outside the range of the network. This would mean that the piconet is no longer a part of the network and should not have a reserved time slot. The movement of this piconet outside the network may free up some secondary timeslots but it will always eliminate one. FIGS. 3a and 3b show a linear network in which a piconet leaves the network. FIGS. 4a and 4b show a nonlinear network in which a piconet leaves the network. FIG. 5 shows a flowchart of the process whereby a departing piconet is detected and dropped, and network operation continues.

See FIG. 5. In step 51, by comparing its current APB to the image of its previous APB, a piconet master detects that a neighboring piconet is no longer present.

In step 52, the detecting piconet sets its BDBF to all zeros and calculates the CEC. (ΔT=N−M)

In step 53, the detecting piconet freezes its APB, until CEC is reached, or it receives another CEC.

In step 54, the detecting piconet master propagates the zeros and CEC in its beacon to all other piconet masters that it can hear.

When a BDBF of all zeros is received by any piconet, that piconet first propagates the zero BDBF and freezes its APB.

In step 55, each piconet then sends its updated BDBF in its beacon. This BDBF consists of the logical OR-ing of its audible bitmap (APB) with any BDBF received from a master that has previously transmitted a zero BDBF.

If the CEC is reached (step 56) and there are still missing piconets, or zeros in the BDBF, then those piconets are officially dropped from the network as in step 57b. Also, at this time each master begins updating its audible piconet bitmap. Each piconet master subtracts one from its ID, and shifts its bit map position down by one, for each BDBF zero that it detects before its position in the bitmap. The piconet that ends up in the first position of the bitmap automatically assumes the role of incrementing the BCC, and thus becomes the root.

If the BDBF has no zeroes at the CECC point, operation continues without change as in step 57a.

A specific example: Suppose a linear network where each piconet, except for the first and last piconets, is only connected to two other piconets. See FIG. 3a. (Note: The linear configuration is the worst possible in terms of number of links between piconets. All ΔT values are calculated assuming a linear configuration.) If piconet C were to leave the network (see FIG. 3b) both piconets B and D would detect this. B and D would each set the BDBF to zeros and tell all other piconets to set their BDBF to zeros. Then each would set the CEC to the current cycle count+(N−M). In this case N=5 (C is still treated as a member of the network), and M=1 (since both B and D are currently only connected to one other piconet). After (5−1), or 4, cycle counts, piconet C would be dropped from the network.

In this case the network will split into two new networks as a by-product of the invention's process. Piconets A and B are still connected to each other but they cannot hear piconets D and E, as in FIG. 3b. The same is true for D and E—they cannot hear A and B. Therefore, when piconet C is dropped from the entire network, A and B form a network and D and E form another network. This all happens by the end of 7 cycle counts after piconet C leaves the network. Piconet D then becomes the root piconet of its network because it has a smaller ID number than E, and piconet A retains the title of root piconet for its network. Piconet D will then be in charge of updating the cycle count for the network containing piconets D and E. (Do not confuse root piconet with a network master. The invention's method allows a network to exist without the use of a network master.)

TABLE 3

Single Node Drop Beacon
Sequence

| | | | | | | | | |
|---|---|---|---|---|---|---|---|---|
| BCC | PN 1 | PN 2 | PN 3 | PN 4 | PN 5 | PN 6 | PN 7 | PN 8 |

| | | | | | | | | |
|---|---|---|---|---|---|---|---|---|
| 1 | 11111111 | 11111111 | 11111111 | 11111111 | 11111111 | 11111111 | 11111111 | 11111111 |
| | — | — | — | — | — | — | — | — |
| 2 | 11111111 | 11111111 | --------- | 00000000 | 00000000 | 00000000 | 00000000 | 00000000 |
| CEC | 0 | 0 | | 8 | 8 | 8 | 8 | 8 |
| 3 | 11111111 | 00000000 | --------- | 00001001 | 00011111 | 00011111 | 01011111 | 00001001 |
| CEC | 0 | 8 | | 8 | 8 | 8 | 8 | 8 |
| 4 | 00000000 | 11011111 | --------- | 00011111 | 01011111 | 01011111 | 11011111 | 00011111 |
| CEC | 8 | 8 | | 8 | 8 | 8 | 8 | 8 |
| 5 | 11011111 | 11011111 | --------- | 01011111 | 11011111 | 11011111 | 11011111 | 01011111 |
| CEC | 8 | 8 | | 8 | 8 | 8 | 8 | 8 |
| 6 | 11011111 | 11011111 | --------- | 11011111 | 11011111 | 11011111 | 11011111 | 11011111 |
| CEC | 8 | 8 | | 8 | 8 | 8 | 8 | 8 |
| 7 | 11011111 | 11011111 | --------- | 11011111 | 11011111 | 11011111 | 11011111 | 11011111 |
| CEC | 8 | 8 | | 8 | 8 | 8 | 8 | 8 |
| 8 | 1111111 | 1111111 | 1111111 | 1111111 | 1111111 | 1111111 | 1111111 | --------- |
| | — | — | — | — | — | — | — | — |

FIGS. 4a and 4b show a more complex (nonlinear) network configuration. This example is used to show how the network is rebuilt after a change is detected. Table 3 (above) will help to show how the bitmaps are filled during each cycle count. For this example piconet three will be dropped from the network. The drop process can be followed by stepping down through the rows of Table 3.

In Table 3, PN stands for Piconet, the ones and zeros represent the BDBF, and the 8 underneath the BDBF is the calculated CEC. The CEC is derived from the formula CEC=BCC+N−M, where N is the number of piconets in the network and M is the number of piconets that the CEC setting piconet can hear at that time. Piconet 3 does not leave until BCC=2.

At BCC=8 piconet 3 is officially dropped from the network, and all bit maps are compressed. Piconet 4 becomes 3, piconet 5 becomes 4 and so on.

Movement of a Piconet in the Network

A piconet is free to move about the network. This movement will consequently causes a change in the number of piconets with which a given piconet interferes. Therefore, every time a piconet moves, free time slots must be redetermined. There are two possible situations for movement within the network. One is a piconet moving out of range of one piconet and into range of another.

Here is the series of steps in this case:
A piconet master detects that a neighboring piconet is no longer present.
The detecting piconet master sets its BDBF to zeros and calculates the CEC. (ΔT=N−M)
The detecting piconet master freezes its audible piconets bitmap
The detecting piconet master stops using all other secondary time slots
The detecting piconet master propagates the zeros and CEC to all other piconet masters that it can hear.
Each piconet ORs the BDBF with its audible piconet bitmap and propagates the updated BDBF
If the piconet originally detected as not present is found in the network by any piconet master, then the BDBF is correctly put back together and the network has then established that all piconets are still there.

This process is almost identical to dropping a piconet from the network.

The second type of movement is a piconet moving into range of another piconet, while remaining in range of an original piconet.
A piconet detects a new piconet in its audible piconet bitmap.
That piconet stops using all secondary time slots
The piconet then updates its audible piconet bitmap and proceeds as normal.
   Advantages of this Network Implementation

a) Secondary time slots: A secondary time slot occurs when a network is spread out enough so that not all piconets in that network can hear each other. When a first piconet cannot hear a second piconet that is in the network, then that first piconet is waiting while the bandwidth is unused. This extra time is called a secondary time slot. To make efficient use of the bandwidth, the first piconet has the option of using the secondary slot and giving up the slot when it is no longer needed. (A piconet may never give up its primary slot unless it leaves the network.) The secondary slot is the reason for the secondary slot bitmap (SSB) and the available slot bitmap (ASB) that each piconet maintains. The audible piconet bitmap (APB) is different for each piconet. The method a piconet uses for taking a secondary slot is as follows. The piconet:
Checks its ASB to find all available slots
Picks one secondary slot, marks the slot in its SSB as taken, and transmits the SSB to all other piconets in range to notify them which slot is taken
Uses the secondary slot at its appropriate time
Gives up the secondary slot when it is no longer needed.

b) Multiple Actions, Single Execution: One difficult situation that this method handles with ease occurs when two network-change actions take place concurrently, before the first of the two network-change actions is fully executed. In such a scenario, a first piconet is propagating a BDBF of zeros and a CEC throughout the network. During this interval, a second piconet that has not received the zeros also detects a change, and begins to propagate a BDBF of zeros and a different CEC. For each piconet in the network, the rules for resolving this are:
If a piconet has not received the zeros, then listen for any changes.
If a change is detected then propagate a BDBF of zeros and a CEC
Freeze the audible piconet bitmap
If a different BDBF of zeros and CEC is received then compare the two CEC values.
If the NNF is set then execute the add new network action first, otherwise, pick the smallest CEC at which to begin execution.
Take another look and freeze audible piconet bitmap if the new CEC is adopted.
Proceed as in the cases for dropping or moving piconets.

If a piconet needs to be added during the execution or propagation of an action, then it is told to wait until after the action is executed at the CEC.

Two conditions for the above rules are: First, once a piconet receives a BDBF of zeroes, that piconet may not listen for or detect any more changes, unless it receives a different BDBF causing it to look at its APB. Second, once the CEC is reached then all piconets must compare their frozen APB to the current state of their APB. If there is a difference, then that new change must be signaled in the network by broadcasting a new BDBF of all zeros.

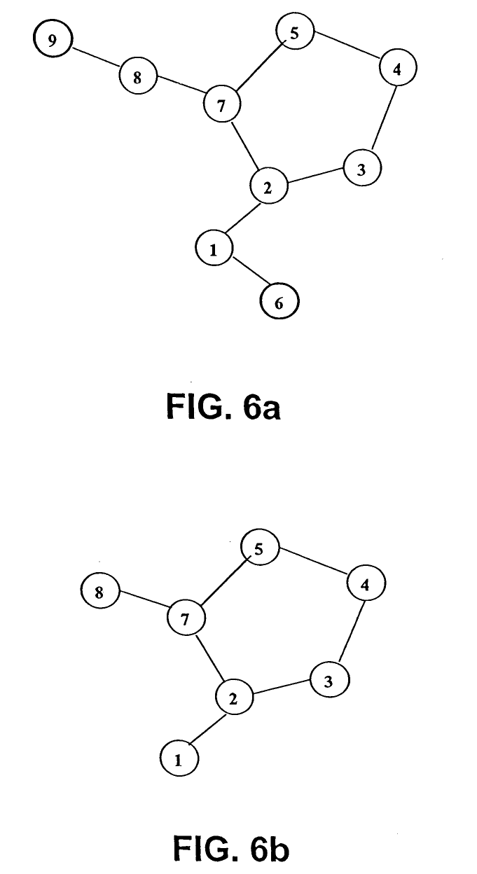

FIGS. 6a and 6b show another network configuration and Table 4 a chart (below) showing the BDBF sequence of a network handling two piconets dropping at one CEC. FIG. 6a shows the network before the dropping of piconets 6 and 9, and FIG. 6b shows the network after both piconets 6 and 9 are dropped. The process is similar to the process explained above for the single node drop, and is illustrated row by row in Table 4, with FIGS. 6a and 6b serving as references.

Joining Two Meshes of Piconets

Two meshes of piconets may join when initial contact is established between them in one of two ways. First, a piconet in one mesh detects a beacon sent by a piconet in a second mesh. This is the simpler case, requiring that the two meshes merge. Second, an inactive node (an inactive piconet) is activated in a location where it detects beacons from two separate and non-connected piconet meshes. This is the more complex case, described here.

TABLE 4

Two Node Drop Beacon
Sequence

| | | | | | | | | | |
|---|---|---|---|---|---|---|---|---|---|
| BCC | PN 1 | PN 2 | PN 3 | PN 4 | PN 5 | PN 6 | PN 7 | PN 8 | PN 9 |

| | | | | | | | | | |
|---|---|---|---|---|---|---|---|---|---|
| ID | 100000000 | 010000000 | 001000000 | 000100000 | 000010000 | 000001000 | 000000100 | 000000010 | 000000001 |
| bits | | | | | | | | | |
| APB | 010001000 | 101000100 | 010100000 | 001010000 | 000100100 | 100000000 | 010010010 | 000000101 | 000000010 |
| 1 | 111111111 | 111111111 | 111111111 | 111111111 | 111111111 | 111111111 | 111111111 | 111111111 | 111111111 |
| CEC | --- | --- | --- | --- | --- | --- | --- | --- | --- |
| 2 | 111111111 | 111111111 | 111111111 | 111111111 | 111111111 | 111111111 | 111111111 | 111111111 | Unjoin |
| | --- | --- | --- | --- | --- | --- | --- | --- | --- |

| | |
|---|---|
| CEC = BCC + N − M − Q | BCC = 3, N = 9, M = 1, Q = 1 |

| | | | | |
|---|---|---|---|---|
| APB | PN 8 < PN 9, therefore Q = 1 | (otherwise Q = 0) | 000000100 | none |

| | | | | | | | | | |
|---|---|---|---|---|---|---|---|---|---|
| 3 | 111111111 | 111111111 | 111111111 | 111111111 | 111111111 | 111111111 | 111111111 | 000000000 | --------- |
| | --- | --- | --- | --- | --- | --- | --- | 11 | |
| 4 | 111111111 | 111111111 | 111111111 | 111111111 | 111111111 | 111111111 | 000000000 | 000000100 | --------- |
| | --- | --- | --- | --- | --- | --- | 11 | 11 | |
| 5 | 111111111 | 000000000 | 000000000 | 000000000 | 000000000 | Unjoin | 010010010 | 010010110 | --------- |
| | --- | 11 | 11 | 11 | 11 | --- | 11 | 11 | |

| | | |
|---|---|---|
| 010000000 | CEC = BCC + N − M − Q = 13 | Since 13 > 11, 11 is retained |

| | | | | | | | | | |
|---|---|---|---|---|---|---|---|---|---|
| 6 | 000000000 | 101000100 | 111100100 | 111110100 | 111110110 | --------- | 111110110 | 111110110 | --------- |
| | 11 | 11 | 11 | 11 | 11 | | 11 | 11 | |
| 7 | 111000100 | 111110110 | 111110110 | 111110110 | 111110110 | --------- | 111110110 | 111110110 | --------- |
| | 11 | 11 | 11 | 11 | 11 | | 11 | 11 | |
| 8 | 111110110 | 111110110 | 111110110 | 111110110 | 111110110 | --------- | 111110110 | 111110110 | --------- |
| | 11 | 11 | 11 | 11 | 11 | | 11 | 11 | |
| 9 | 111110110 | 111110110 | 111110110 | 111110110 | 111110110 | --------- | 111110110 | 111110110 | --------- |
| | 11 | 11 | 11 | 11 | 11 | | 11 | 11 | |
| 10 | 111110110 | 111110110 | 111110110 | 111110110 | 111110110 | --------- | 111110110 | 111110110 | --------- |
| | 11 | 11 | 11 | 11 | 11 | | 11 | 11 | |

| | | | | | | | | |
|---|---|---|---|---|---|---|---|---|
| 11 | 1111111 | 1111111 | 1111111 | 1111111 | 1111111 | 1111111 | 1111111 | BDBF, 7 bits |

| | | | | | | |
|---|---|---|---|---|---|---|
| --- | --- | --- | --- | --- | --- | --- |

Overall Mesh Join Process Description

Each mesh is made up of one or more piconets each having one or more stations. One of the stations in each piconet is designated a master station. “Master station” here means a master station for the piconet, not a master station for the network. As described for earlier cases, the invention eliminates the need for a network master. The master station in a piconet emits a beacon containing the following information:
Beacon Cycle Number (BCN)
Mesh ID Number (MID)
Piconet Index Number (PIN)
Total number of joined piconets in the mesh (TMM)
Change Effect Beacon Cycle (CEC)
New Mesh Flag (NMF), used to indicate an impending join to the mesh
New Mesh Size (NMS), used to reflect the number of piconets in the joining mesh
No Beacon Detect (NBD) indication
Beacon Detect Bitmap Flag (BDBF) having a bit for each joined piconet master (with the order of the bits being the order of the ID's of the joined piconet master stations).

Each joined piconet master in the mesh transmits its beacon once during each beacon cycle in order according to its PIN, and transmits a variable length field consisting of a Data Type Field (DTF), a Data Length Field (DLF), and the Data Field (DF).

The unjoined piconet master station receives the beacons of each joined piconet's master station that is within range, selects one of the joined piconet master stations to act as a Facilitator for joining the mesh, and replies to the selected Facilitator's beacon with a request to join the mesh, which includes a JMS (Join-Merge Start) set to the value 1.

In response to the request to join the mesh from the unjoined master station, the Facilitator calculates and transmits in its beacon:
A CEC equal to BCN+M−N−1 (where N is the number of joined piconet master beacons heard by the Facilitator)
The Facilitator's MID (mesh ID number)
An assigned PIN for the unjoined piconet;
The PIN of the Facilitator;
The Facilitator's BCN,
M; the total number of joined piconet masters before any master went off-line,
An NNF set to indicate an impending join to the mesh.

The unjoined piconet master station receives the beacon from the Facilitator, thereby becoming a joined piconet of the mesh, and transmits a beacon when BCN equals CEC and each beacon cycle thereafter according to its assigned PIN.

Each joined piconet master receives a Beacon Cycle Count Number, BCN, from the join facilitator JPM and all other JPM's within range, and transmits a BCN in the current beacon that is one greater than the BCN transmitted in the previous beacon.

One of the joined piconet master stations stops transmission of its beacon.

One of the remaining joined piconet master stations detects the stopping of beacon transmission.

The remaining joined piconet master station transmits in its own beacon, a No Beacon Detect (NBD) indication, and a Change Effect Cycle Count (CEC) value equal to current BCN+M−N, where M is the total number of joined piconet masters before any master went off-line and N is the number of joined piconet masters whose beacons are now heard by the remaining joined piconet master station.

Each joined piconet master that has not already transmitted an NBD, but has received an NBD in the beacon from any other joined piconet master, transmits (thus repeating) an NBD and the smallest CEC received from any master station in its own next beacon.

Every joined piconet master that has transmitted a beacon with an NBD transmits in its next beacon a Beacon Detect Bitmap Flag (BDBF) having non zero values in locations representing piconet masters that can be heard by that piconet master station.

Every joined piconet master station receives the BDBFs, logically ORs all of the BDBFs together to produce an ORed BDBF, and stores and transmits in its next beacon the ORed BDBF.

Every joined piconet master station receives the ORed BDBFs, logically ORs the ORed BDBFs with its stored BDBF to produce an updated BDBF, and stores and transmits the updated BDBF; and repeats the steps of receiving, OR-ing, storing and transmitting until the cycle count BCN is equal to the value CEC.

When BCN equals CEC, every joined piconet master compresses the BDBF bitmap to eliminate any position indicating that no joined piconet master could hear the beacon of the piconet master represented by the position.

Each joined piconet master reduces its network ID by one for each eliminated position present for a piconet master having a smaller ID.

Each joined piconet master resumes beacon transmissions at the new beacon time specified by its modified beacon ID.

Each joined piconet master receives a Beacon Cycle Count Number, BCN, from the join facilitator JPM and all other JPM's within range.

Each joined piconet master transmits a BCN in the current beacon that is one greater than the BCN transmitted in the previous beacon.

Detailed Join-Merge-Resync Process Description

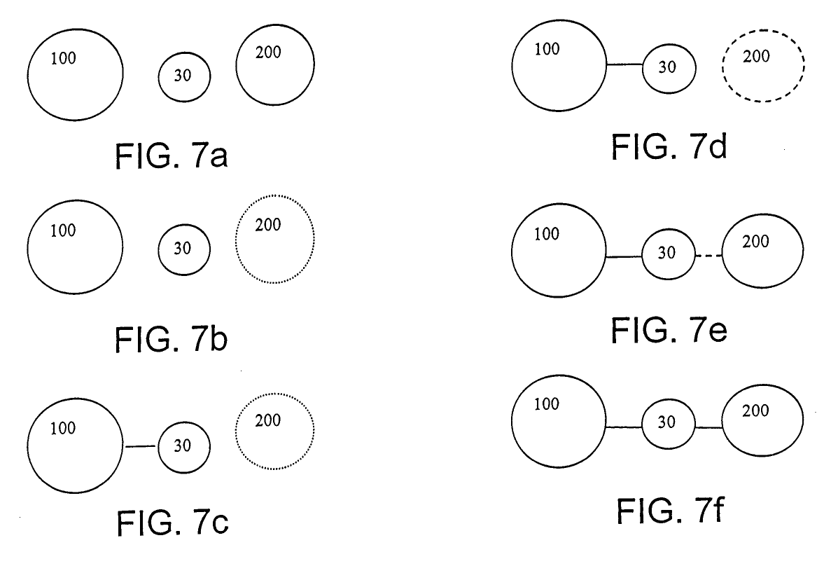

FIGS. 7a through 7f, 8a through 8f, and 9a through 9f provide details and diagrams for the description which follows. FIGS. 7a through 7f show the stages of joining an unjoined piconet master, a join mesh, and a merge mesh, in the case where the join mesh's join time exceeds the merge mesh's beacon turn-off time.

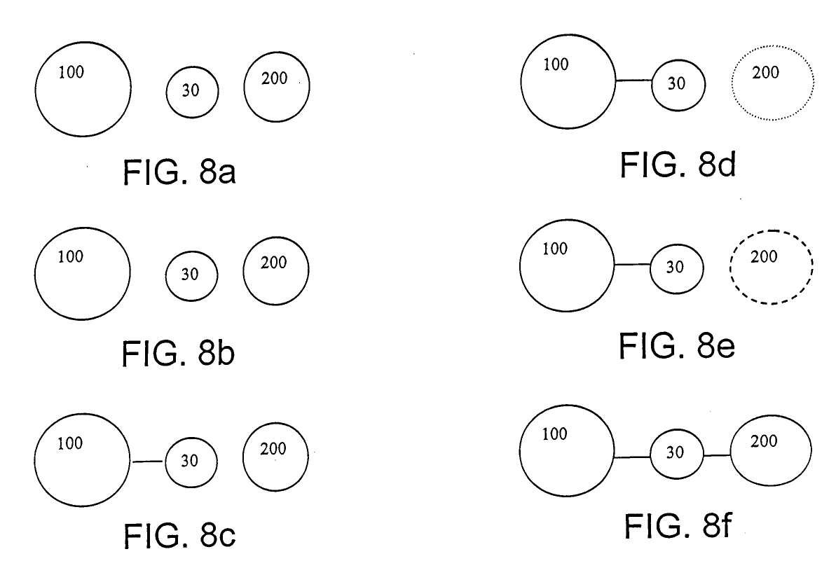

FIGS. 8a through 8f show the stages of joining an unjoined piconet master, a join mesh, and a merge mesh, in the case where the join mesh's join time is less than or equal to the merge mesh's beacon turn-off time.

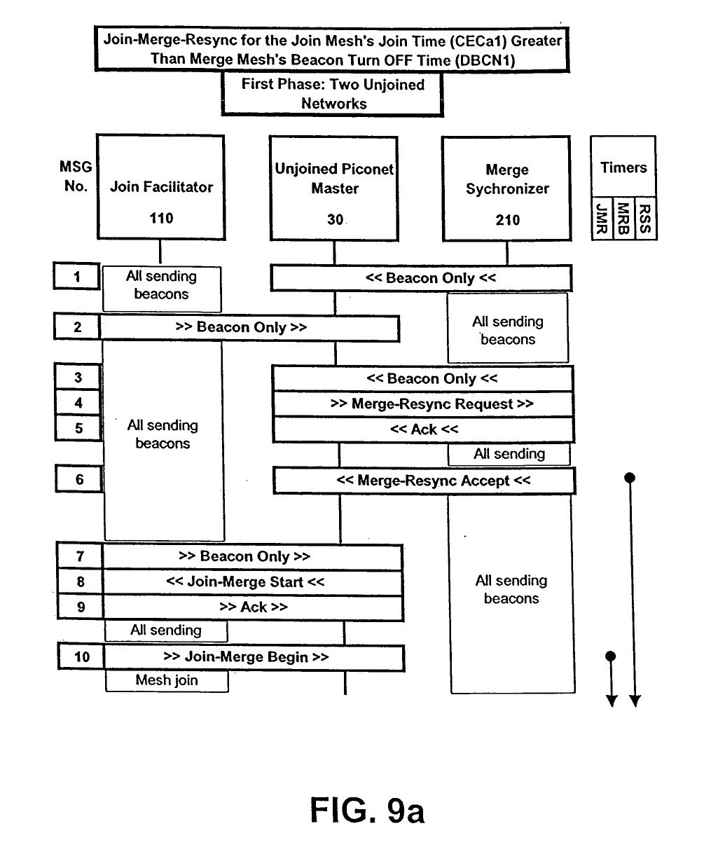

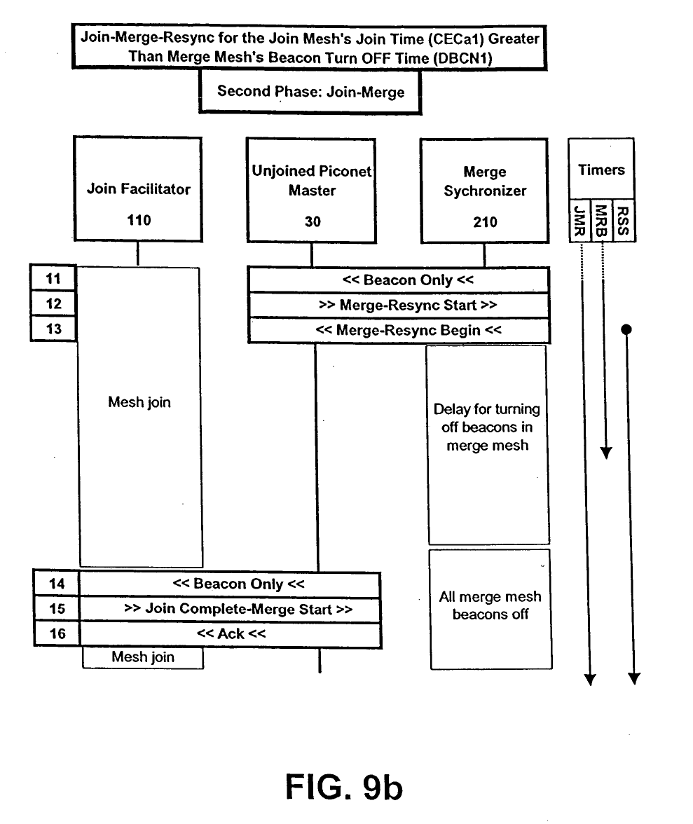

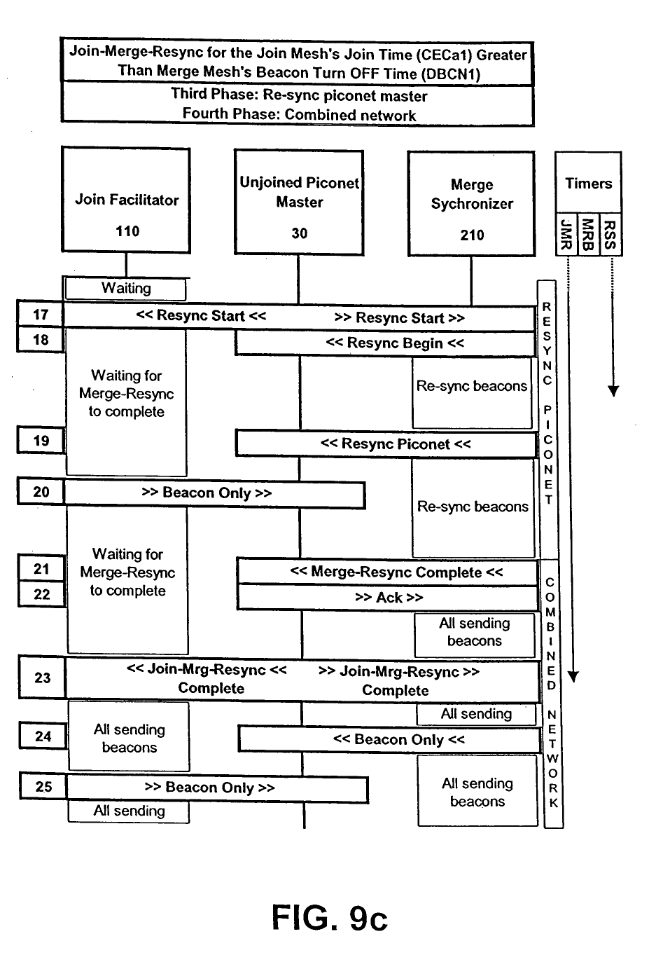

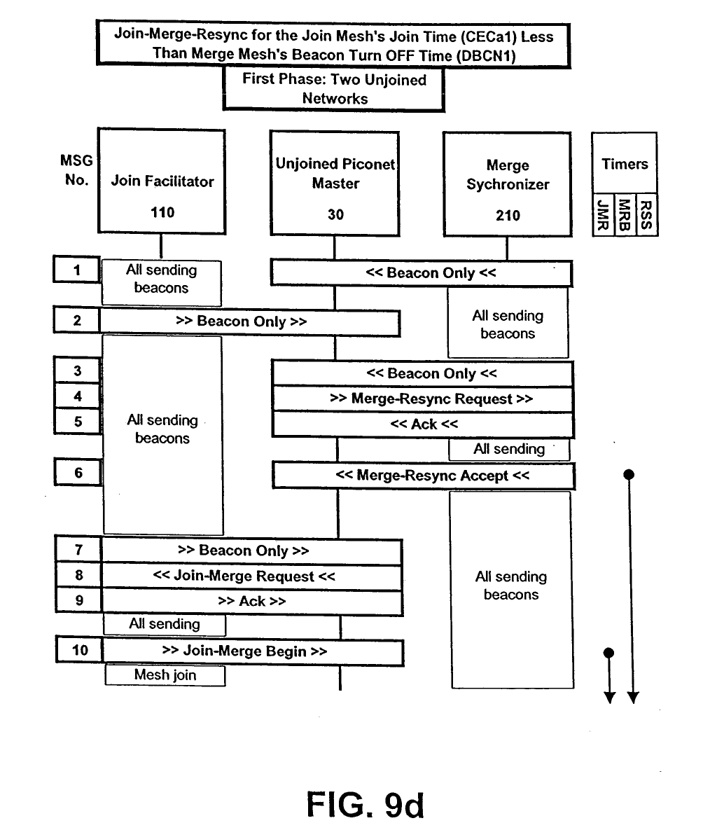

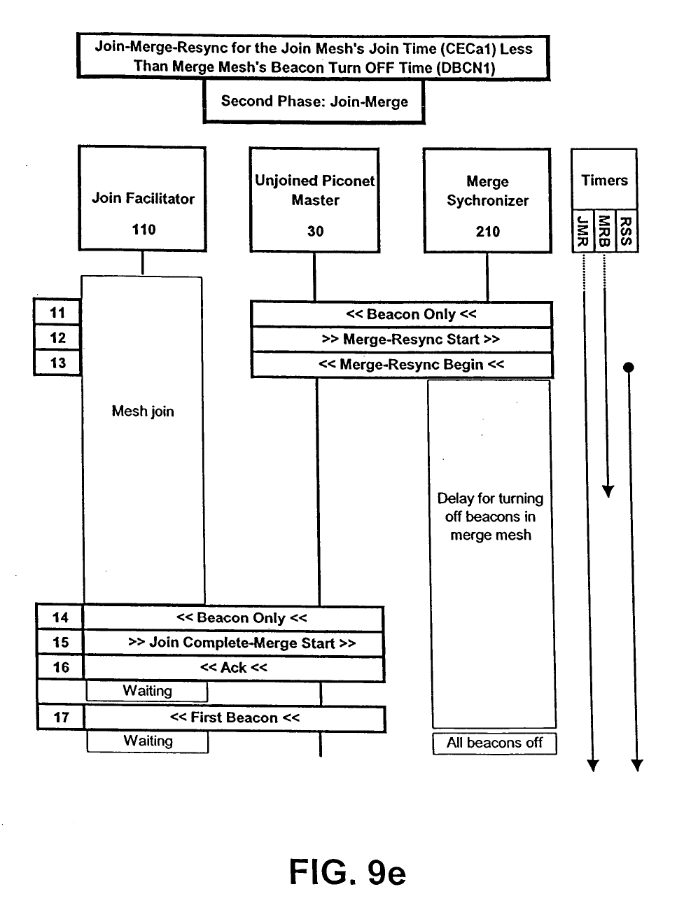

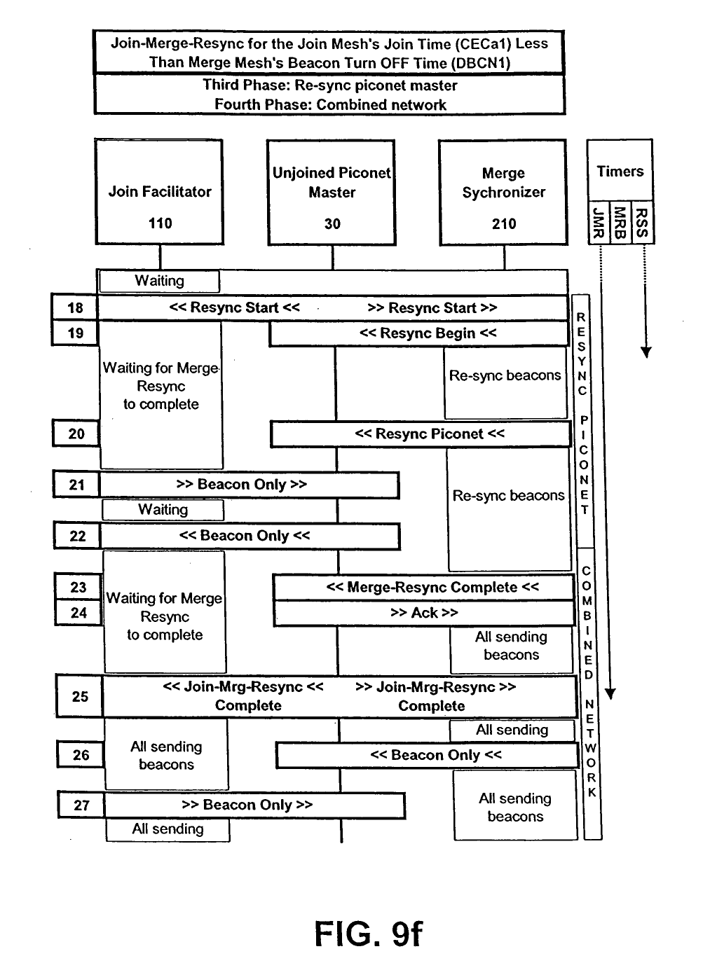

FIGS. 9a through 9c show the general message flow during the joining of an unjoined piconet master, a join mesh, and a merge mesh, in the case where the join mesh's join time is greater than the merge mesh's beacon turn-off time.

FIGS. 9d through 9f show the general message flow during the joining of an unjoined piconet master, a join mesh, and a merge mesh, in the case where the join mesh's join time is less than or equal to the merge mesh's beacon turn-off time.

FIGS. 7a and 8a show the initial state of the networks involved. All are isolated from each other. Mesh 100 is the larger, mesh 200 is the smaller, and unjoined piconet master 30 is a single piconet not connected either to mesh 100 or mesh 200.

See FIG. 9a. An unjoined piconet master 30 hears beacons (in Msg. Nos. 2 and 1 respectively, FIG. 9a) from two piconet masters 110 and 210 in meshes 100 and 200 with different mesh IDs. The different mesh IDs indicate that the masters 110 and 210 in meshes 100 and 200 are from different meshes. In the complex case being described here, the unjoined piconet master 30 itself has a third mesh ID. The unjoined piconet master 30 begins a process, called here Join-Merge-Resync, that results in a single mesh consisting of all joined piconet masters in both meshes 100 and 200 plus the unjoined piconet master 3.

The unjoined piconet master 30 assigns the mesh with the largest number of members as the mesh to join, or the “join mesh” 100. The master of the join mesh 100 is termed here the “join facilitator” master 110. The unjoined piconet master 30 assigns the second mesh 200, defined as the “merge mesh”, to be combined with the join mesh 100. The master of the merge mesh is termed here the “merge synchronizer” master 210.

The join mesh 100 has a number of piconet masters stored as size NTM1. The number of joined piconet masters that can be heard by the join facilitator master 110 is stored as value APC1. The merge mesh has a number of piconet masters stored as size NTM2. The number of joined piconet masters that the merge synchronizer 210 can hear is stored as value APC2.

In response to the merge synchronizer master 210 beacon, the unjoined piconet master 30 transmits a “Merge-Resync Request” (Msg. No. 4, FIG. 9a) containing the size of the join mesh 100, NTM1.

The merge synchronizer master 210 transmits a “Merge-Resync Accept” reply (Msg. No. 6, FIG. 9a) in its next beacon. The transmitted beacon includes:
The merge mesh 200 size, NTM2;
The merge mesh 200 watchdog timer called MRS-WTO. The merge synchronizer master 210 sets the MRS-WTO timer here to 2*(NTM1−PIN1) in units of beacon intervals T_{b}. The MRS-WTO timer value is set to be greater than the delay anticipated for receiving the “Merge-Resync Start” reply from the unjoined piconet master (UPM) 30.
A value DBCN2, the estimated number of merge network 200 beacon cycles required for the merge synchronizer 210 to propagate a command throughout the network.

The eventual anticipated “Merge-Resync Start” reply from the unjoined piconet master 30 will command the merge synchronizer 210 to begin its next operation.

In response to the normal join facilitator master 110 beacon (Msg. No. 7, FIG. 9a), the unjoined piconet master 30 transmits a “Join-Merge Start” (Msg. No. 8, FIG. 9a) that includes:
The total size of the network to be merged, NTM3, having the value of the size of the merge mesh 200 plus one (for the unjoined piconet master 30), NTM2+1;
The value DBCN1=DBCN2*(NTM1/NTM2), the value of DBCN2 expressed in units of the join network's beacon cycles.

The join facilitator master 110 transmits a beacon with a “Join-Merge Begin” command (Msg. No. 10, FIG. 9a) including the following:
The NMF set to indicate the a new mesh is joining, 1, and the NMM set to the total number of nodes in the mesh network plus 1, NTM3;
The join watchdog timer for the entire join-merge-resync process, JMR-WTO, with a value greater than DBCN1+CECa1+1 join network beacon cycles if CECa1≧DBCN1, and greater than 2*DBCN1+1 otherwise;
A join network CEC value of CECa1 for the join-merge-resync operation.

The first phase of the process, during which the meshes 100 and 200 are separate as shown in FIGS. 7a and 8a, is now complete. The second phase, called the Join-Merge phase, now begins.

In response to the join facilitator 110 beacon (Msg. No. 11, FIG. 9b), the unjoined piconet master 30 transmits a “Merge-Resync Start” command (Msg. No. 12, FIG. 9b) with parameters NTM1 and NTM3, and with beacon elements NMF=1 and NMM=NTM3 to indicate a merge in progress.

Responding to the “Merge-Resync Start” command, the merge facilitator 210 begins turning off the merge mesh 200 beacons and transmits the “Merge-Resync Begin” command (Msg. No. 13, FIG. 9b) with:
CEC=CECb2, the command propagation time for a command sent by the merge synchronizer 210 to the merge mesh 200;
Beacon elements NMF=1 and NMM=NTM3 to indicate a merge in progress;
A watchdog timer RSS-WTO, which is used to make sure that the “Resync Start” command is issued by the unjoined piconet master (UPM) 30 near the expected CECa2 beacon cycle.

At this stage the next step depends on which of two events occurs first. In the first case the merge mesh reaches beacon turn-off time DBCN1 before the join mesh BCN reaches the value CECa1. In the second case, the join mesh BCN reaches the value CECa1 before the merge mesh reaches its beacon turn-off time. These cases are described separately below.

Case 1: Merge Mesh Reaches Beacon Turn-Off Time DBCN1 before the Join Mesh BCN Reaches Value CECa1

See FIGS. 7a through 7f, and 9a through 9c. FIG. 7b shows merge mesh 200 with beacons turning off (dotted outline). The unjoined piconet master (UPM) 30 transmits a beacon (Msg. No. 14, FIG. 9b), and the join facilitator 110 sends the “Join Complete-Merge Start” command (Msg. No. 15, FIG. 9b) to the unjoined piconet master (UPM) 30, with:
Beacon elements NMF=1 and NMM=NTM3 indicating the merge in progress;
Beacon element MID=MID1 to identify the join mesh 100;
Beacon elements PIN=PIN1 and NTM=NTM1, providing the PIN and NTM for the join mesh 100.

This completes the second phase of the process, and the third phase, the res-synchronization of the piconet masters, begins.

When all merge mesh 200 beacons have stopped, the UPM 30 transmits a “Resync Start” command (Msg. No. 17, FIG. 9c) to both meshes with:
Beacon elements NMF=1 and NMM=NTM3 indicating the merge in progress;
Beacon element MID=MID3 to identify the UPM 30;
Beacon elements PIN=1 and NTM=1 for the isolated UPM 30.

The merge synchronizer 210 responds to the “Resync Start” by sending a “Resync Begin” message (Msg. No. 18, FIG. 9c) to the UPM 30, with:
Beacon elements NMF=2 and NMM=NTM3 indicating the resynchronization in progress;
Beacon element MID=MID2 to identify the merge mesh 200;
Beacon elements PIN=PIN2 for the PIN of the merge synchronizer 210 and NTM=NTM2 for the merge mesh 200 size.

The merge synchronizer 210 then resynchronizes its piconet. During the resynchronization of the merge mesh 200 beacons, the merge synchronizer 210 sends to the UPM the “Resync Piconet” message (Msg. No. 19, FIG. 9c) showing the same beacon elements as in the “Resync Begin” message. The join facilitator 110 during this stage is sending only beacon (s).

See FIG. 7e for the relationships among the meshes at this point. Once the merge mesh is resynchronized, the merge synchronizer 210 sends a “Merge-Resync complete” message (Msg. No. 21, FIG. 9c) to the UPM 30, with:
Beacon elements NMF=2 and NMM=NTM3 indicating the resynchronization in progress;
Beacon element MID=MID1 to identify the join mesh 100 with which the merge mesh 200 is combining;
Beacon elements PIN=PIN4 for the newly-resynchronized PIN of the merge synchronizer 210 and NTM=NTM3 for the mesh size of the merge mesh 200 and the unjoined piconet master 30 being added to the join mesh 100.

The UPM 30 returns an acknowledgement. At this point the two networks 100 and 200 have been fully merged and resynchronized, with every piconet in both of the original meshes uniquely identified and operating in the fully-merged mesh. The UPM 30 responds to the“Merge-Resync complete” message by sending to both the join facilitator and the merge synchronizer a “Join-Merge Resync Complete” message (Msg. No. 23, FIG. 9c), with:
Beacon elements NMF=0 and NMM=0, signifying completion of all join, merge, and resynchronization steps, and normal operation of the fully-joined mesh;
Beacon element MID=MID 1 to identify the join mesh 100 with which the merge mesh 200 has combined;
Beacon elements PIN=PIN3 for the resynchronized PIN of the UPM 30 and NTM=NTM4 for the new total mesh size for the join and merge meshes 100 and 200 and the unjoined piconet master 30.

From this point forward the mesh operates as one (FIG. 7f).

Case 2: Join Mesh BCN Reaches Value CECa1 before Merge Mesh Reaches Beacon Turn-Off Time DBCN1

See FIGS. 8a through 8f, and 9d through 9f. In the second case the join mesh 100 BCN reaches the value CECa1 and the join facilitator 110 sends the “Join Complete-Merge Start” command (Msg. No. 15, FIG. 9e) to the unjoined piconet master (UPM) 30 before the merge mesh 200 reaches beacon turn-off time DBCN1. The “Join Complete-Merge Start” command includes:
Beacon elements NMF=1 and NMM=NTM3 indicating the merge in progress;
Beacon element MID=MID1 to identify the join mesh 100;
Beacon elements PIN=PIN1 and NTM=NTM1, providing the PIN and NTM for the join mesh 100.

In this case the merge mesh 200 beacons are still sending. At some point during the merge mesh 200 beacon shutdown process, the UPM 30 sends a first beacon (Msg. No. 17, FIG. 9e) to the join facilitator 110 with:
Beacon elements NMF=0 and NMM=0;
Beacon element MID=MID1 to identify the join mesh 100;
Beacon elements PIN=PIN3 and NTM=NTM3, providing the new PIN of the UPM 30 and the NTM showing the number of members for the merge mesh 200 plus the UPM.

When all merge mesh 200 beacons have stopped, the UPM 30 transmits a “Resync Start” command (Msg. No. 18, FIG. 9F) to both meshes with:
Beacon elements NMF=2 and NMM=NTM3 indicating the resynchronization in progress;
Beacon element MID=MID3 to identify the UPM 30;
Beacon elements PIN=1 and NTM=1 for the isolated UPM 30.

The merge synchronizer 210 responds to the “Resync Start” by sending a “Resync Begin” message (Msg. No. 19, FIG. 9f) to the UPM 30, with:
Beacon elements NMF=2 and NMM=NTM3 indicating the resynchronization in progress;
Beacon element MID=MID2 to identify the merge mesh 200;
Beacon elements PIN=PIN2 for the PIN of the merge synchronizer 210 and NTM=NTM2 for the merge mesh 200 size.

The merge synchronizer 210 then resynchronizes its piconet 200. During the resynchronization of the merge mesh 200 beacons, the merge synchronizer 210 sends to the UPM 30 the “Resync Piconet” message (Msg. No. 20, FIG. 9f) showing the same beacon elements as in the “Resync Begin” message. The join facilitator 110 during this stage is sending only beacon (s), to which the UPM 30 is responding with beacons of its own, with:
Beacon elements NMF=0 and NMM=0;
Beacon element MID=MID1 to identify the UPM 30;
Beacon elements PIN=PIN3 for the PIN of the UPM 30 and NTM=NTM3 showing the number of members for the merge mesh 200 plus the UPM.

Once the merge mesh 200 is resynchronized, the merge synchronizer 210 sends a “Merge-Resync complete” message (Msg. No. 23, FIG. 9f) to the UPM 30, with:
Beacon elements NMF=2 and NMM=NTM3 indicating the resynchronization in progress;
Beacon element MID=MID1 to identify the join mesh 100 with which the merge mesh 200 is combining;
Beacon elements PIN=PIN4 for the newly-resynchronized PIN of the merge synchronizer 210 and NTM=NTM3 for the mesh size of the merge mesh 200 and the unjoined piconet master 30 being added to the join merge mesh 100.

The UPM 30 returns an acknowledgement. At this point the two meshes 100 and 200 have been fully merged and resynchronized, with every piconet in both of the original meshes uniquely identified and operating in the fully-merged mesh. The UPM 30 responds to the“Merge-Resync complete” message by sending to both the join facilitator 110 and the merge synchronizer 210 a “Join-Merge Resync Complete” message (Msg. No. 25, FIG. 9f), with:
Beacon elements NMF=0 and NMM=0, signifying completion of all join, merge, and resynchronization steps, and normal operation of the fully-joined mesh, shown in FIG. 8f;
Beacon element MID=MID1 to identify the join mesh 100 with which the merge mesh 200 has combined;
Beacon elements PIN=PIN3 for the newly-resynchronized PIN of the UPM 30 and NTM=NTM4 for the new total mesh size for the join and merge meshes 100 and 200 and the unjoined piconet master 30.

From this point forward the mesh operates as one.

The invention has been described in detail with particular reference to certain preferred embodiments thereof, but it will be understood that variations and modifications can be effected within the spirit and scope of the invention.

1. A method for managing a wireless network of piconets, comprising the steps of:
adding together two networks of piconets;
removing a piconet from the network; and
accommodating movement of a piconet within a network.

2. The method of claim 1 wherein the step of adding together two networks of piconets further comprises the steps of:
a first detecting piconet in a first network detecting a second detecting piconet in a second network;
the second detecting piconet detecting the first detecting piconet;
the first and second detecting piconets exchanging overall network size parameters for comparison;
the detecting piconet in the smaller network of the first and second piconets sending to the detecting piconet in the larger network a request to join the larger network;
the detecting piconet in the smaller network shutting down;
the piconets of the smaller network receiving new ID numbers created by adding their current ID number to the size of the larger network;
the smaller network adopting the larger network's cycle count;
the network size being updated to reflect all piconets in both networks;
the detecting piconet in the larger network expanding the map of all piconets in the network;
the detecting piconet in the larger network propagating the expanded map of all piconets in the network to all other piconets in the expanded network;
all piconets in the expanded network propagating the expanded map in their transmissions;
any missing piconets being detected and removed from the expanded map of all piconets in the network.

3. The method of claim 1 wherein the step of removing a piconet from the network further comprises the steps of:
a first piconet master detecting that a neighboring piconet is no longer present;
the first piconet master setting a timer to allow for propagation of the loss of the lost neighboring piconet;
the first piconet master transmittting a loss flag to signal the loss of the lost neighboring piconet;
all piconets receiving the loss flag and propagating the loss flag to their neighboring piconets;
each piconet signaling the identities of all the piconets it can hear, pooled with the identities of all the piconets audible to the other piconets in the network;
if any piconets in the network not audible to any signaling piconet, dropping all non-audible piconets from the network; and
all piconets remapping the network to eliminate any lost piconets.

4. The method of claim 1 wherein the step of accommodating movement of a piconet within a network further comprises the steps of:
a first piconet master detecting that a neighboring piconet is no longer present;
the first piconet master transmittting a loss flag to signal the loss of the lost neighboring piconet;
all piconets receiving the loss flag and propagating the loss flag to their neighboring piconets;
each piconet signaling the identities of all the piconets it can hear, pooled with the identities of all the piconets audible to the other piconets in the network;
if any piconets in the network not audible to any signaling piconet, dropping all non-audible piconets from the network;
if any piconets in the network detect one or more new piconets, adding the new piconets to the network; and
all piconets remapping the network to eliminate any lost piconets and incorporate any new piconets.

5. The method of claim 1 wherein the step of adding together two networks of piconets further comprises the steps of:
an unjoined piconet detecting two mutually noncommunicating piconet meshes;
the unjoined piconet determining which of the two piconet meshes is larger;
the unjoined piconet assigning a join facilitator piconet in the larger piconet mesh;
the unjoined piconet assigning a merge synchronizer piconet in the larger piconet mesh;
the unjoined piconet requesting the smaller piconet mesh to stop its beacon transmissions;
the smaller piconet mesh stopping its beacon transmissions;
the unjoined piconet requesting the larger piconet mesh to accommodate the smaller piconet mesh and the unjoined piconet in the beacon cycle of the larger piconet mesh;
the larger piconet mesh expanding its map of piconets to accommodate the smaller piconet mesh and the unjoined piconet;
the smaller piconet mesh signaling the unjoined piconet when it has stopped its beacon transmissions;
the larger piconet mesh signaling the unjoined piconet when the larger piconet mesh has completed accommodating the smaller piconet mesh and the unjoined piconet in the beacon cycle of the larger piconet mesh;
the smaller piconet mesh and the unjoined piconet joining the larger piconet mesh;
the smaller piconet mesh and the unjoined piconet resuming beacon transmissions as part of the larger piconet mesh.

6. A method for a piconet to use unused time slots in a piconet beacon cycle, comprising the steps of:
having each first piconet keep a table of piconets in network that the first piconet cannot hear;
the first piconet selecting a slot from the table;
the first piconet marking the slot as taken;
the first piconet transmitting the marked slot to the other piconets in the network to notify them of its use;
the first piconet using the slot to transmit data;
the first piconet marking the slot as no longer in use; and
the first piconet transmitting the marked slot to the other piconets in the network to notify them of its release.

7. A method of controlling and sharing access to a wireless network wherein some stations of the network may be out of range of other stations of the network, comprising the steps of:
a) each station periodically transmitting a beacon containing a bit map having a bit location for every station on the network and monitoring the beacons of stations within its range;
b) in response to a beacon being no longer detected, a station transmitting a bit map containing an indication of only the stations that it can still receive;
c) in response to a station receiving a bit map with not all stations indicated, adding stations that it can receive to the received bit map and transmitting the updated bit map;
d) repeating step c) until the updated bit map indicates that all stations are still in the network or that a station is missing from the network; and
e) if a station is indicated to be missing from the network, updating the bit map, whereby the access to the network is controlled without a global master.

8. A method of controlling and sharing access by an unjoined piconet to a wireless communication mesh of joined piconets, comprising the steps of:
a) providing a plurality of piconets having one or more stations, one of the stations in each piconet being designated a master station and emitting a beacon containing fields for a Beacon Cycle Number (BCN), a mesh ID Number (MID), a piconet index Number (PIN), the total number of joined piconets in the mesh (TMM), a Change Effect Beacon Cycle (CEC), a New Mesh Flag (NMF) to indicate an impending join to the mesh, a New Mesh Size, (NMS) the number of piconets in the joining mesh, a No Beacon Detect (NBD) indication, and a Beacon Detect Bitmap Flag (BDBF) having a bit for each joined piconet master (with the order of the bits being the order of the ID's of the joined piconet master stations), each joined piconet master in the mesh transmitting its beacon once during each beacon cycle in order according to its PIN, and a variable length field consisting of a Data Type Field (DTF), a Data Length Field (DLF), and the Data Field (DF);
b) the unjoined piconet master station receiving the beacons of each joined piconet's master station that is within range, selecting one of the joined piconet master stations to act as a Facilitator for joining the mesh, and replying to the selected Facilitator's beacon with a request to join the mesh, which includes a JMS set to the value 1;
c) in response to the request to join the mesh from the unjoined master station, the Facilitator calculating and transmitting in its beacon a CEC equal to BCN+M−N−1 (where N is the number of joined piconet master beacons heard by the Facilitator), MIN, an assigned PIN for the unjoined piconet, the PIN of the Facilitator, the Facilitator's BCN, M, and an NNF set to indicate an impending join to the mesh;
d) the unjoined piconet master station receiving the beacon from the Facilitator, becoming a joined piconet of the mesh, and transmitting a beacon when BCN equals CEC and each beacon cycle thereafter according to its assigned PIN, each joined piconet master receiving a Beacon Cycle Count Number, BCN, from the join facilitator JPM and all other JPM's within range, and transmitting a BCN in the current beacon that is one greater than the BCN transmitted in the previous beacon;
e) one of the joined piconet master stations stopping transmission of its beacon;
f) one of the remaining joined piconet master stations detecting the stopping of transmission;
g) the remaining joined piconet master station transmitting in its own beacon, a No Beacon Detect (NBD) indication and a Change Effect Cycle Count (CEC) value equal to current BCN+M−N, where M is the total number of joined piconet masters before any master went off-line and N is the number of joined piconet masters whose beacons are now heard by the remaining joined piconet master station;
h) each joined piconet master that has not already transmitted an NBD, but has received an NBD in the beacon from any other joined piconet master, transmitting (thus repeating) an NBD and the smallest CEC received from any master station in its own next beacon;
i) every joined piconet master that has transmitted a beacon with an NBD transmitting in its next beacon a Beacon Detect Bitmap Flag (BDBF) having non zero values in locations representing piconet masters that can be heard by that piconet master station;
j) every joined piconet master station receiving the BDBFs, logically OR-ing all of the BDBFs together to produce an ORed BDBF, and storing and transmitting in its next beacon the ORed BDBF; and
k) every joined piconet master station receiving the ORed BDBFs, logically OR-ing the ORed BDBFs with its stored BDBF to produce and updated BDBF, and storing and transmitting the updated BDBF; and repeating the steps of recieveing, OR-ing storing and transmitting until the cycle count BCN is equal to the value CEC.

9. The method claimed in claim 8, further comprising the steps of:
a) when BCN equals CEC, compressing the BDBF bitmap to eliminate any position indicating that no joined piconet master could hear the beacon of the piconet master represented by the position;
b) each joined piconet master reducing its network ID by one for each eliminated position present for a piconet master having a smaller ID; and
c) each joined piconet master resuming beacon transmissions at the new beacon time specified by its modified beacon ID.

10. The method claimed in claim 9, further comprising the steps of:
a) each joined piconet master receiving a Beacon Cycle Count Number, BCN, from the join facilitator JPM and all other JPM's within range; and
b)transmitting a BCN in the current beacon that is one greater than the BCN transmitted in the previous beacon.

11. The method claimed in claim 10, further comprising the steps of:
a) An unjoined piconet master hearing beacons from two piconet's masters eeach with a different mesh ID indicating that the masters are from different meshes, and beginning a process that will result in single mesh consisting of all joined piconet masters in both meshes plus the unjoined piconet master, and shall be called Join-Merge-Resync;
b) the unjoined piconet master using an algorithm, in this case the mesh with the largest number of members as the mesh to join, or “join mesh”, whose master is the “join facilitator” master, and a mesh to be merged with this first mesh, defined as the “merge mesh”, whose master is the “merge synchronizer” master;
c) the join mesh having a size NTM1 piconet masters, and the number of joined piconet masters that can be heard by the join facilitator master is APC1, and the merge mesh having a size NTM2, and the number of joined piconet masters that the merge synchronizer can hear is APC2;
d) the unjoined piconet master transmitting a “Merge-Resync Request” in response to the merge synchronizer master beacon, containing the size of the join mesh, NTM 1;
e) the merge synchronizer master transmitting a “Merge-Resync Accept” reply in its next beacon that includes its mesh size, NTM2, and its watchdog timer called MRS-WTO, whose value shall be greater than the anticipated delay to receiving the “Merge-Resync Start” reply from the UPM, commanding the merge synchronizer to begin its next operaton, and the MRS-WTO timer is set here to 2*(NTM1-PIN1) in units of beacon intervals Tb, and sending a value DBCN2, the estimated number of merge network beacon cycles required for the merge synchronizer to propagate a command throughout the network;
f) the unjoined piconet master transmitting a “Join-Merge Start” in response to the join facilitator master beacon, that includes: the total size of the network to be merged, NTM3, having the value of the size of the merge network plus one, NTM2+1, and the value DBCN1=DBCN2*(NTM1/NTM2), the value of DBCN2 expressed in units of the join network's beacon cycles.;
g) the join facilitator master transmitting a beacon with a “Join-Merge Begin” command including the following: the NMF set to indicate the a new mesh is joining, 1, and the NMM set to the total number of nodes in the mesh network plus 1, TMM3, and the join watchdog timer for the entire join-merge-resync process, JMS-WTO, with a value greater than DBCN1+CECa1+1 join network beacon cycles if CECa1>=DBCN1, and greater than 2*DBCN1+1 otherwise, and a join network CEC value of CECa1 for the join-merge-resync operation.
h) the unjoined piconet master transmitting a “Merge-Resync Start” command in response to the join facilitator beacon, with parameters NTM1 and NTM3, and with beacon elements NMF=1 and NMM=NTM3 to indicate a merge in progress;
the merge facilitator responding to the “Merge-Resync Start” command by transmitting “Merge-Resync Begin” command with CEC=CECb2=the command propagation time for a command sent by the merge synchronizer to the merge network, and with beacon elements NMF=1 and NMM=NTM3 to indicate a merge in progress, and with a watchdog timer RSS-WTO, which is used to make sure that the “Resync Start” command is issued by the UPM near the expected CECa2 beacon cycle.
